(19) United States
(12) Patent Application Publication
(10) Pub. No.: US 2012/0330559 A1
(43) Pub. Date: Dec. 27, 2012

(54) SYSTEMS AND METHODS FOR HYBRID ASSEMBLY OF NUCLEIC ACID SEQUENCES

(75) Inventors: Hongshan JIANG, Beijing (CN); Zhao XU, Beijing (CN); Max INGMAN, Adelaide (AU)

(73) Assignee: LIFE TECHNOLOGIES CORPORATION, Carlsbad, CA (US)

(21) Appl. No.: 13/528,470

(22) Filed: Jun. 20, 2012

Related U.S. Application Data
(60) Provisional application No. 61/499,634, filed on Jun. 21, 2011.
(60) Provisional application No. 61/501,551, filed on Jun. 27, 2011.

(51) Int. Cl. G06F 19/10

(52) U.S. Cl. 702/19

(57) ABSTRACT

Systems and methods for assembling a nucleic acid sequence are disclosed. A plurality of single fragment sequence reads and a plurality of paired fragment sequence reads are received. Each paired fragment sequence read comprises at least two sequence reads separated by an insert. Single fragment sequence reads are assembled into a plurality of contigs, and the paired fragment sequence reads are mapped to the contigs. Further, gap regions comprising a portion of the partially assembled nucleic acid sequence for which the single fragment sequence reads do not map are identified, and hanging pairwise sequence reads of the mapped paired fragment sequence reads are used to fill in the gap region.

### CROSS-REFERENCE TO RELATED APPLICATIONS

This application claims priority to U.S. Ser. No. 61/499,634, filed Jun. 21, 2011, and U.S. Ser. No. 61/501,551, filed Jun. 27, 2011, the disclosures of which are hereby incorporated herein by reference in their entirety as if set forth fully herein.

### FIELD

The present disclosure generally relates to the field of nucleic acid sequencing including systems and methods for reconstructing large continuous genome sequences from fragmented sequence reads.

### INTRODUCTION

Upon completion of the Human Genome Project, one focus of the sequencing industry has shifted to finding higher throughput and/or lower cost nucleic acid sequencing technologies, sometimes referred to as “next generation” sequencing (NGS) technologies. In making sequencing higher throughput and/or less expensive, the goal is to make the technology more accessible for sequencing. These goals can be reached through the use of sequencing platforms and methods that provide sample preparation for larger quantities of samples of significant complexity, sequencing larger numbers of complex samples, and/or a high volume of information generation and analysis in a short period of time. Various methods, such as, for example, sequencing by synthesis, sequencing by hybridization, and sequencing by ligation are evolving to meet these challenges.

Research into fast and efficient nucleic acid (e.g., genome, exome, etc.) sequence assembly methods is vital to the sequencing industry as NGS technologies can provide ultra-high throughput nucleic acid sequencing. As such sequencing systems incorporating NGS technologies can produce a large number of short sequence reads in a relatively short amount time. Sequence assembly methods must be able to assemble and/or map a large number of reads quickly and efficiently (i.e., minimize use of computational resources). For example, the sequencing of a human size genome can result in tens or hundreds of millions of reads that need to be assembled before they can be further analyzed to determine their biological, diagnostic and/or therapeutic relevance.

Sequence assembly can generally be divided into two broad categories: de novo assembly and reference genome mapping assembly. In de novo assembly, sequence reads are assembled together so that they form a new and previously unknown sequence. Whereas in reference genome mapping, sequence reads are assembled against an existing backbone sequence (e.g., reference sequence, etc.) to build a sequence that is similar but not necessarily identical to the backbone sequence.

In particular, NGS sequencing data presents a number of challenges to de novo assembly algorithm design. For example, nucleic acid sequencing data generated by NGS sequencing platforms such as Roche 454, Illumina GAIIx, and Life Technologies' SOLiD and Ion Torrent PGM platforms typically present shorter read lengths, higher coverage, and higher error rates than traditional Sanger sequencing data. To adapt to this situation, most assemblers are specifically optimized and tuned to process sequencing data for a particular NGS platform. For instance, Newbler and CABOG are assemblers that are designed to handle longer read NGS sequencing data (such as 454 and Ion Torrent data), whereas the former was distributed by 454 Life Sciences and the latter is a Sanger-era overlap-layout-consensus (OLC) assembler (i.e. Celera Assembler) optimized for processing 454 data. Velvet, AllPaths, ABySS, and SOAPdenovo are widely used de Bruijin graph (DBG) based assemblers that have been optimized to process shorter read NGS sequencing data (such as GAIIx and SOLiD data).

Sequencing data from each of the NGS platforms has their own particular advantages and drawbacks. For instance, as discussed to above, Ion Torrent PGM and 454 typically produce longer read NGS sequencing data with read lengths that are greater than 100 bp, which is longer than sequence read data generated by the GAIIx and SOLID NGS platforms, which is typically between 25-100 bp. The longer reads typically are easier to assemble into longer contigs. However, GAIIx and SOLiD typically has much higher throughput than 454 or Ion Torrent PGM, which results in lower cost per sequencing run. Additionally, 454 reads can contain homopolymer indel errors that are uncommon in Illumina and SOLiD reads.

Therefore, in order to assemble large or repetitive genomes in a cost-efficient yet accurate way, it can be advantageous to do a “hybrid” assembly to utilize advantages of different sequencing technologies, e.g. long read lengths of 454 or Ion Torrent reads and ultra high-throughput yet low-cost of SOLiD reads.

### SUMMARY

Systems, methods, software and computer-usable media for reconstructing larger continuous biomolecule-related sequences (e.g., contigs, exomes, genomes, etc.) from smaller biomolecule-related sequence reads are disclosed. Biomolecule-related sequences can relate to proteins, peptides, nucleic acids, and the like, and can include structural and functional information such as secondary or tertiary structures, amino acid or nucleotide sequences, sequence motifs, binding properties, genetic mutations and variants, and the like.

Using nucleic acids as an example, in various embodiments, smaller nucleic acid sequence reads (fragments) of varying lengths can be assembled into larger sequences using a sequence fragment assembly method that initially assembles the longer read fragments into contigs, maps (aligns) the shorter read mate-pair fragments to the contigs to form a scaffold and then collects “hanging” mates of the shorter mate-pair fragments to perform local assemblies to fill the “gap” regions within scaffold. In various embodiments, the sequence reads can be optionally pre-processed to correct read errors within the read fragments or to filter out lower quality read fragments altogether prior to mapping and/or scaffolding. In various embodiments, after the mapping step, the mapped reads can optionally be processed to correct for misassemblies in the contigs using the mapping results.

In various embodiments, the nucleic acid sequence read data can be generated using various techniques, platforms or technologies, including, but not limited to: capillary electrophoresis, microarrays, ligation-based systems, polymerase-based systems, hybridization-based systems, direct or indirect nucleotide identification systems, pyrosequencing, ion- or pH-based detection systems, electronic signature-based systems, etc.

In one aspect, a system for implementing a de novo assembly method can include a computing device (hosting and/or running one or more modules for implementing the de novo assembly method) in communications with one or more sequencing data sources, is disclosed. In various embodiments, the computing device can be a workstation, mainframe computer, personal computer, mobile device, etc.

In various embodiments, the computing device can host a contig assembly module, a mapping module, a scaffolding module and a gap-fill module. The contig assembly module can be configured to assemble a plurality of long nucleic acid sequence reads (typically >100 bps) into a plurality of contiguous sequences, wherein each of the plurality of contiguous sequences (contigs) is comprised of two or more long nucleic acid sequence reads. The mapping module can be configured to map a plurality of short paired (mate-pairs) nucleic acid sequence reads (typically 25-100 bps) to the contigs. The scaffolding module can be configured to take the data output from the mapping module to form a scaffold of the original nucleic acid sequence wherein the scaffold comprises a plurality of contiguous sequences separated by a gap region. The gap-fill module can be configured to utilize the hanging pairwise sequences of the assembled paired sequence reads to fill in the gap region.

In various embodiments, the computing device can optionally host a pre-processing module that can be configured to correct read errors within the read fragments or to filter out lower quality read fragments altogether.

In various embodiments, the computing device can optionally host an error correction module that can be configured to process the data output from the mapping module to correct for misassemblies in the contigs using the mapping results.

In another aspect, a de novo assembly method can include assembling a set of long nucleic acid sequence reads into contigs (wherein the set of long nucleic acid sequence reads are comprised of sequence read fragments longer than about 100 bps), mapping a set of short nucleic acid sequence reads to the contigs (wherein the set of short nucleic acid sequence reads are comprised of mate-pair read fragments less than about 100 bps), forming a nucleic acid sequence scaffold from the set of short nucleic acid sequence reads mapped to the contigs (wherein the scaffold is comprised of a plurality of contiguous sequences separated by gap regions) and utilizing the hanging pairwise sequences of the mapped short nucleic acid sequences to fill in the gap regions.

These and other features are provided herein.

### DRAWINGS

For a more complete understanding of the principles disclosed herein, and the advantages thereof, reference is now made to the following descriptions taken in conjunction with the accompanying drawings, in which:

FIG. 1 is a block diagram that illustrates a computer system, in accordance with various embodiments.

FIG. 2 is a schematic diagram of a system for de novo assembly of a nucleic acid sequence, in accordance with various embodiments.

FIG. 3 is a flowchart showing a de novo assembly method, in accordance with various embodiments.

FIG. 4 is an exemplary flowchart showing a method for de novo assembly of a nucleic acid sequence, in accordance with various embodiments.

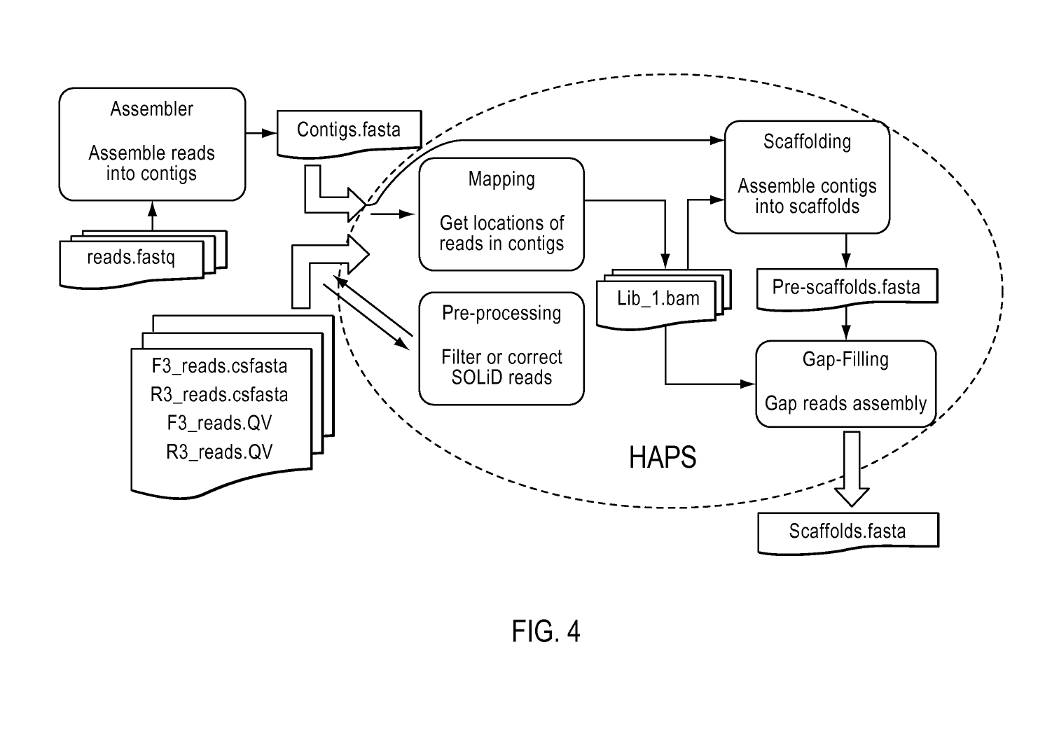

FIGS. 5A and 5B are diagrams showing how a hanging mate pair gap-fill technique can be applied to de novo assembly applications to fill in gap areas in a nucleic acid sequence scaffold assembled from mate-pair sequences mapped to contigs, in accordance with various embodiments.

FIG. 6 is a block diagram of a nucleic acid sequencing platform, in accordance with various embodiments.

FIG. 7 is an exemplary flowchart detailing how the error correction module operates to correct the contig assembly prior to scaffolding, in accordance with various embodiments.

FIG. 8 is an exemplary flowchart detailing how the scaffolding module assembles the contigs and fragment reads into a scaffold of a nucleic acid sequence, in accordance with various embodiments.

FIG. 9 is an exemplary flowchart detailing how the gap-filling module operates to fill in the gap regions in the scaffold, in accordance with various embodiments.

It is to be understood that the figures are not necessarily drawn to scale, nor are the objects in the figures necessarily drawn to scale in relationship to one another. The figures are depictions that are intended to bring clarity and understanding to various embodiments of apparatuses, systems, and methods disclosed herein. Wherever possible, the same reference numbers will be used throughout the drawings to refer to the same or like parts. Moreover, it should be appreciated that the drawings are not intended to limit the scope of the present teachings in any way.

### DESCRIPTION OF VARIOUS EMBODIMENTS

Embodiments of systems and methods for reconstructing larger continuous sequences (e.g., contigs) from smaller fragment sequence reads are described in this specification. In this detailed description, for purposes of explanation, numerous specific details are set forth to provide a thorough understanding of certain embodiments. One skilled in the art will appreciate, however, that certain embodiments may be practiced without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of certain embodiments.

All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control.

The section headings used herein are for organizational purposes only and are not to be construed as limiting the described subject matter in any way.

In this detailed description of the various embodiments, for purposes of explanation, numerous specific details are set forth to provide a thorough understanding of the embodiments disclosed. One skilled in the art will appreciate, however, that these various embodiments may be practiced with or without these specific details. In other instances, structures and devices are shown in block diagram form. Furthermore, one skilled in the art can readily appreciate that the specific sequences in which methods are presented and performed are illustrative and it is contemplated that the sequences can be varied and still remain within the spirit and scope of the various embodiments disclosed herein.

All literature and similar materials cited in this application, including but not limited to, patents, patent applications, articles, books, treatises, and internet web pages are expressly incorporated by reference in their entirety for any purpose. Unless defined otherwise, all technical and scientific terms used herein have the same meaning as is commonly understood by one of ordinary skill in the art to which the various embodiments described herein belongs. When definitions of terms in incorporated references appear to differ from the definitions provided in the present teachings, the definition provided in the present teachings shall control.

It will be appreciated that there is an implied “about” prior to the temperatures, concentrations, times, etc. discussed in the present teachings, such that slight and insubstantial deviations are within the scope of the present teachings. In this application, the use of the singular includes the plural unless specifically stated otherwise. Also, the use of “comprise”, “comprises”, “comprising”, “contain”, “contains”, “containing”, “include”, “includes”, and “including” are not intended to be limiting. It is to be understood that both the foregoing general description and the following detailed description are exemplary and explanatory only and are not restrictive of the present teachings.

Further, unless otherwise required by context, singular terms shall include pluralities and plural terms shall include the singular. Generally, nomenclatures utilized in connection with, and techniques of, cell and tissue culture, molecular biology, and protein and oligo- or polynucleotide chemistry and hybridization described herein are those well known and commonly used in the art. Standard techniques are used, for example, for nucleic acid purification and preparation, chemical analysis, recombinant nucleic acid, and oligonucleotide synthesis. Enzymatic reactions and purification techniques are performed according to manufacturer's specifications or as commonly accomplished in the art or as described herein. The techniques and procedures described herein are generally performed according to conventional methods well known in the art and as described in various general and more specific references that are cited and discussed throughout the instant specification. See, e.g., Sambrook et al., Molecular Cloning: A Laboratory Manual (Third ed., Cold Spring Harbor Laboratory Press, Cold Spring Harbor, N.Y. 2000). The nomenclatures utilized in connection with, and the laboratory procedures and techniques described herein are those well known and commonly used in the art.

As used herein, “a” or “an” means “at least one” or “one or more.”

A “system” denotes a set of components, real or abstract, comprising a whole where each component interacts with or is related to at least one other component within the whole.

A “biomolecule” is any molecule that is produced by a living organism, including large polymeric molecules such as proteins, polysaccharides, lipids, and nucleic acids as well as small molecules such as primary metabolites, secondary metabolites, and other natural products.

The phrase “next generation sequencing” or NGS refers to sequencing technologies having increased throughput as compared to traditional Sanger- and capillary electrophoresis-based approaches, for example with the ability to generate hundreds of thousands of relatively small sequence reads at a time. Some examples of next generation sequencing techniques include, but are not limited to, sequencing by synthesis, sequencing by ligation, and sequencing by hybridization. More specifically, the SOLiD Sequencing System of Life Technologies Corp. provides massively parallel sequencing with enhanced accuracy. The SOLiD System and associated workflows, protocols, chemistries, etc. are described in more detail in PCT Publication No. WO 2006/084132, entitled “Reagents, Methods, and Libraries for Bead-Based Sequencing,” international filing date Feb. 1, 2006, U.S. patent application Ser. No. 12/873,190, entitled “Low-Volume Sequencing System and Method of Use,” filed on Aug. 31, 2010, and U.S. patent application Ser. No. 12/873,132, entitled “Fast-Indexing Filter Wheel and Method of Use,” filed on Aug. 31, 2010, the entirety of each of these applications being incorporated herein by reference thereto.

The phrase “sequencing run” refers to any step or portion of a sequencing experiment performed to determine some information relating to at least one biomolecule (e.g., nucleic acid molecule).

It is well known that DNA (deoxyribonucleic acid) is a chain of nucleotides consisting of 4 types of nucleotides; A (adenine), T (thymine), C (cytosine), and G (guanine), and that RNA (ribonucleic acid) is comprised of 4 types of nucleotides; A, U (uracil), G, and C. It is also known that all of these 5 types of nucleotides specifically bind to one another in combinations called complementary base pairing. That is, adenine (A) pairs with thymine (T) (in the case of RNA, however, adenine (A) pairs with uracil (U)), and cytosine (C) pairs with guanine (G), so that each of these base pairs forms a double strand. As used herein, “nucleic acid sequencing data,” “nucleic acid sequencing information,” “nucleic acid sequence,” “genomic sequence,” “genetic sequence,” or “fragment sequence,” or “nucleic acid sequencing read” denotes any information or data that is indicative of the order of the nucleotide bases (e.g., adenine, guanine, cytosine, and thymine/uracil) in a molecule (e.g., whole genome, whole transcriptome, exome, oligonucleotide, polynucleotide, fragment, etc.) of DNA or RNA. It should be understood that the present teachings contemplate sequence information obtained using all available varieties of techniques, platforms or technologies, including, but not limited to: capillary electrophoresis, microarrays, ligation-based systems, polymerase-based systems, hybridization-based systems, direct or indirect nucleotide identification systems, pyrosequencing, ion- or pH-based detection systems, electronic signature-based systems, etc.

The phrase “ligation cycle” refers to a step in a sequence-by-ligation process where a probe sequence is ligated to a primer or another probe sequence.

The phrase “color call” refers to an observed dye color resulting from the detection of a probe sequence after a ligation cycle of a sequencing run.

The phrase “color space” refers to a nucleic acid sequence data schema where nucleic acid sequence information is represented by a set of colors (e.g., color calls, color signals, etc.) each carrying details about the identity and/or positional sequence of bases that comprise the nucleic acid sequence. For example, the nucleic acid sequence “ATCGA” can be represented in color space by various combinations of colors that are measured as the nucleic acid sequence is interrogated using optical detection-based (e.g., dye-based, etc.) sequencing techniques such as those employed by the SOLiD System. That is, in various embodiments, the SOLiD System can employ a schema that represents a nucleic acid fragment sequence as an initial base followed by a sequence of overlapping dimers (adjacent pairs of bases). The system can encode each dimer with one of four colors using a coding scheme that results in a sequence of color calls that represent a nucleotide sequence.

The phrase “base space” refers to a nucleic acid sequence data schema where nucleic acid sequence information is represented by the actual nucleotide base composition of the nucleic acid sequence. For example, the nucleic acid sequence “ATCGA” is represented in base space by the actual nucleotide base identities (e.g., A, T/or U, C, G) of the nucleic acid sequence.

The phase “flow space” refers to a representation of the incorporation event or non-incorporation event for a particular nucleotide flow. For example, flow space can be a series of zeros and ones representing a nucleotide incorporation event (a one, “1”) or a non-incorporation event (a zero, “0”) for that particular nucleotide flow. It should be understood that zeros and ones are convenient representations of a non-incorporation event and a nucleotide incorporation event; however, any other symbol or designation could be used alternatively to represent and/or identify these events and non-events.

A “polynucleotide”, “nucleic acid”, or “oligonucleotide” refers to a linear polymer of nucleosides (including deoxyribonucleosides, ribonucleosides, or analogs thereof) joined by internucleosidic linkages. Typically, a polynucleotide comprises at least three nucleosides. Usually oligonucleotides range in size from a few monomeric units, e.g. 3-4, to several hundreds of monomeric units. Whenever a polynucleotide such as an oligonucleotide is represented by a sequence of letters, such as “ATGCCTG,” it will be understood that the nucleotides are in 5′->3′ order from left to right and that “A” denotes deoxyadenosine, “C” denotes deoxycytidine, “G” denotes deoxyguanosine, and “T” denotes thymidine, unless otherwise noted. The letters A, C, G, and T may be used to refer to the bases themselves, to nucleosides, or to nucleotides comprising the bases, as is standard in the art.

The techniques of “paired-end,” “pairwise,” “paired tag,” or “mate pair” sequencing are generally known in the art of molecular biology (Siegel A. F. et al., Genomics. 2000, 68: 237-246; Roach J. C. et al., Genomics. 1995, 26: 345-353). These sequencing techniques can allow the determination of multiple “reads” of sequence, each from a different place on a single polynucleotide. Typically, the distance between the two reads or other information regarding a relationship between the reads is known. In some situations, these sequencing techniques provide more information than does sequencing two stretches of nucleic acid sequences in a random fashion. With the use of appropriate software tools for the assembly of sequence information (e.g., Millikin S. C. et al., Genome Res. 2003, 13: 81-90; Kent, W. J. et al., Genome Res. 2001, 11: 1541-8) it is possible to make use of the knowledge that the “paired-end,” “pairwise,” “paired tag” or “mate pair” sequences are not completely random, but are known to occur a known distance apart and/or to have some other relationship, and are therefore linked or paired in the genome. This information can aid in the assembly of whole nucleic acid sequences into a consensus sequence.

### Computer-Implemented System

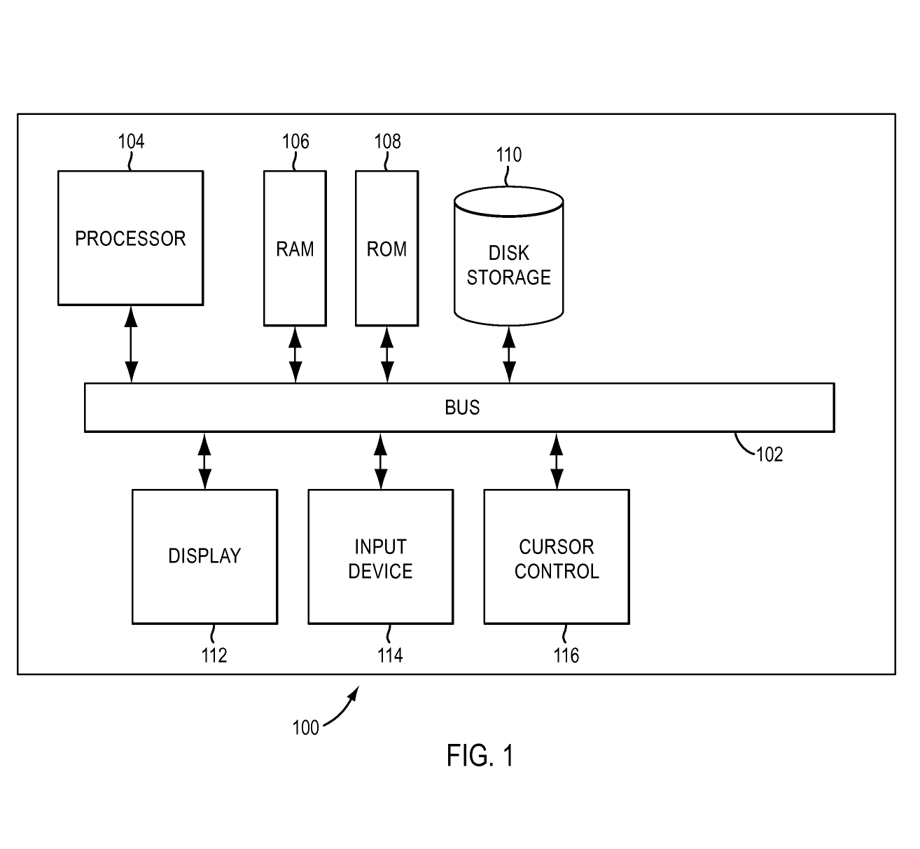

FIG. 1 is a block diagram that illustrates a computer system 100, upon which embodiments of the present teachings may be implemented. In various embodiments, computer system 100 can include a bus 102 or other communication mechanism for communicating information, and a processor 104 coupled with bus 102 for processing information. In various embodiments, computer system 100 can also include a memory 106, which can be a random access memory (RAM) or other dynamic storage device, coupled to bus 102 for determining base calls, and instructions to be executed by processor 104. Memory 106 also can be used for storing temporary variables or other intermediate information during execution of instructions to be executed by processor 104. In various embodiments, computer system 100 can further include a read only memory (ROM) 108 or other static storage device coupled to bus 102 for storing static information and instructions for processor 104. A storage device 110, such as a magnetic disk or optical disk, can be provided and coupled to bus 102 for storing information and instructions.

In various embodiments, computer system 100 can be coupled via bus 102 to a display 112, such as a cathode ray tube (CRT) or liquid crystal display (LCD), for displaying information to a computer user. An input device 114, including alphanumeric and other keys, can be coupled to bus 102 for communicating information and command selections to processor 104. Another type of user input device is a cursor control 116, such as a mouse, a trackball or cursor direction keys for communicating direction information and command selections to processor 104 and for controlling cursor movement on display 112. This input device typically has two degrees of freedom in two axes, a first axis (i.e., x) and a second axis (i.e., y), that allows the device to specify positions in a plane.

A computer system 100 can perform the present teachings. Consistent with certain implementations of the present teachings, results can be provided by computer system 100 in response to processor 104 executing one or more sequences of one or more instructions contained in memory 106. Such instructions can be read into memory 106 from another computer-readable medium, such as storage device 110. Execution of the sequences of instructions contained in memory 106 can cause processor 104 to perform the processes described herein. Alternatively hard-wired circuitry can be used in place of or in combination with software instructions to implement the present teachings. Thus implementations of the present teachings are not limited to any specific combination of hardware circuitry and software.

The term “computer-readable medium” as used herein refers to any media that participates in providing instructions to processor 104 for execution. Such a medium can take many forms, including but not limited to, non-volatile media, volatile media, and transmission media. Examples of non-volatile media can include, but are not limited to, optical or magnetic disks, such as storage device 110. Examples of volatile media can include, but are not limited to, dynamic memory, such as memory 106. Examples of transmission media can include, but are not limited to, coaxial cables, copper wire, and fiber optics, including the wires that comprise bus 102.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, PROM, and EPROM, a FLASH-EPROM, any other memory chip or cartridge, or any other tangible medium from which a computer can read.

Various forms of computer readable media can be involved in carrying one or more sequences of one or more instructions to processor 104 for execution. For example, the instructions can initially be carried on the magnetic disk of a remote computer. The remote computer can load the instructions into its dynamic memory and send the instructions over a telephone line using a modem. A modem local to computer system 100 can receive the data on the telephone line and use an infra-red transmitter to convert the data to an infra-red signal. An infra-red detector coupled to bus 102 can receive the data carried in the infra-red signal and place the data on bus 102. Bus 102 can carry the data to memory 106, from which processor 104 retrieves and executes the instructions. The instructions received by memory 106 may optionally be stored on storage device 110 either before or after execution by processor 104.

In accordance with various embodiments, instructions configured to be executed by a processor to perform a method are stored on a computer-readable medium. The computer-readable medium can be a device that stores digital information. For example, a computer-readable medium includes a compact disc read-only memory (CD-ROM) as is known in the art for storing software. The computer-readable medium is accessed by a processor suitable for executing instructions configured to be executed.

### De Novo Nucleic Acid Sequence Assembly

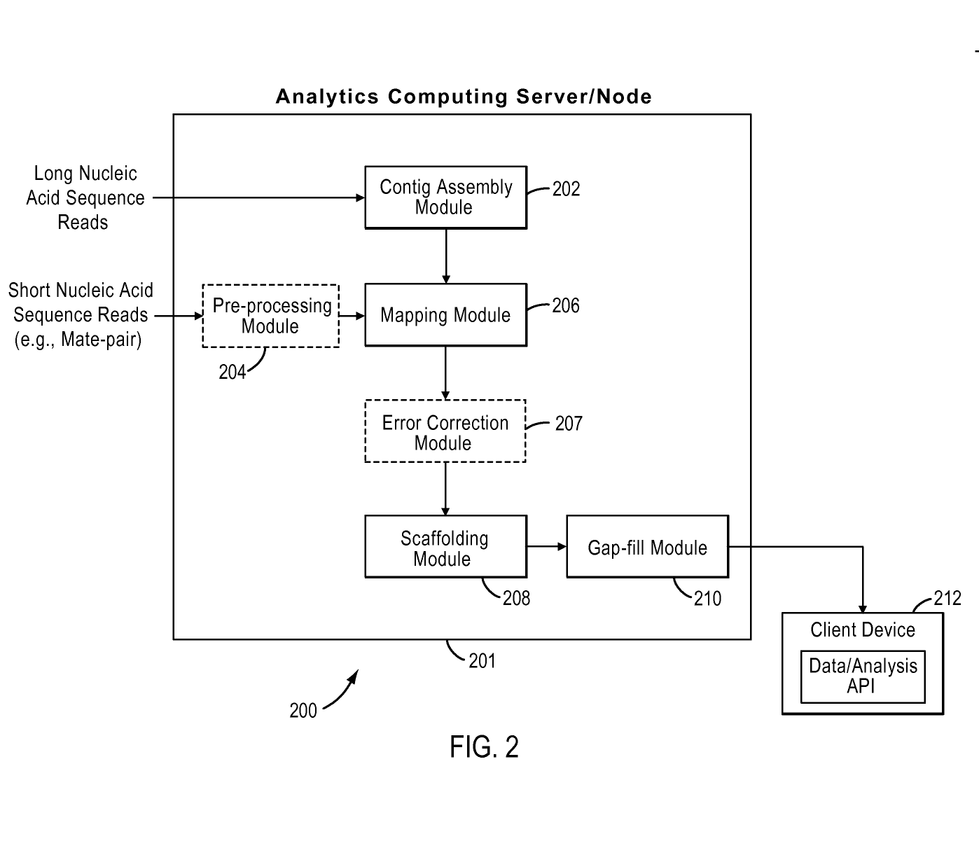

FIG. 2 is a schematic diagram of a system for de novo assembly of a nucleic acid sequence, in accordance with various embodiments.

As shown herein, the system 200 can include an analytics computing server/node 201 in communications with a client device 212 (optional). The analytics computing server/node 201 can be configured to host a contig assembly module 202, a pre-processing module 204 (optional), a mapping module 206, an error correction module 207 (optional), a scaffolding module 208, and a gap-fill module 210. In various embodiments, the analytics computing device/server/node 201 can be a workstation, mainframe computer, personal computer, mobile device, etc.

In various embodiments, the contig assembly module 202 can be configured to assemble long nucleic acid sequence reads (>100 bases) into contigs, such as in FASTA format. Next, the mapping module 206 can be configured to map short nucleic acid mate-pair sequence reads (<100 bases) reads onto these contigs based on a sequence homology between a short nucleic acid mate-pair sequence read and a portion of a contig, for example to produce MA files or a BAM file. With the contigs and the mapping results at hand, the scaffolding module 208 can be used to build scaffolds. After, the gap-fill module 210 can be used to fill intra-scaffold gaps. In various embodiments, a pre-processing module 204 (e.g., SAET, etc.) can be used to enhance short nucleic acid mate-pair sequence read accuracy.

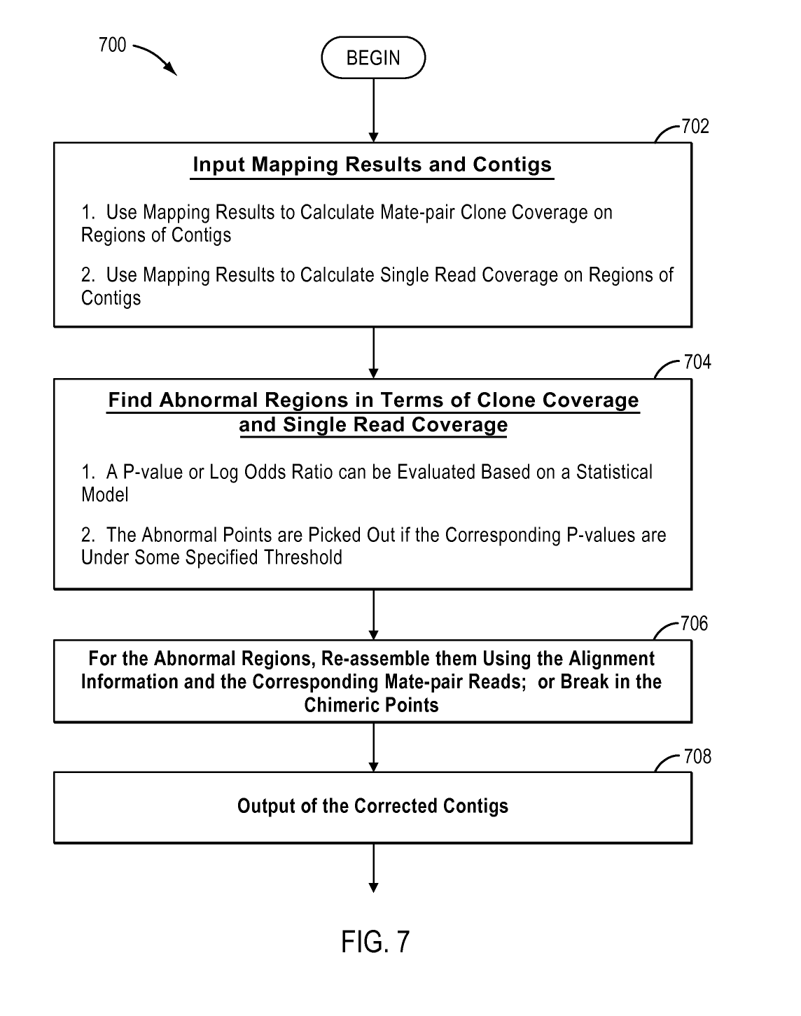

FIG. 7 is an exemplary flowchart detailing how the error correction module operates to correct the contig assembly prior to scaffolding, in accordance with various embodiments. As shown herein, in step 702, mapping results are utilized to calculate single read (long nucleic acid sequence reads) and mate-pair (short nucleic acid sequence reads) clone coverage on the regions of the contigs. In step 704, abnormal regions of single read and mate-pair clone coverage of the contigs are found. In step 706, the abnormal regions are either re-assembled using the alignment information of the corresponding mate-pair reads; or, the chimeric points are broken. In step 708, the corrected contigs are output from the error correction module 207.

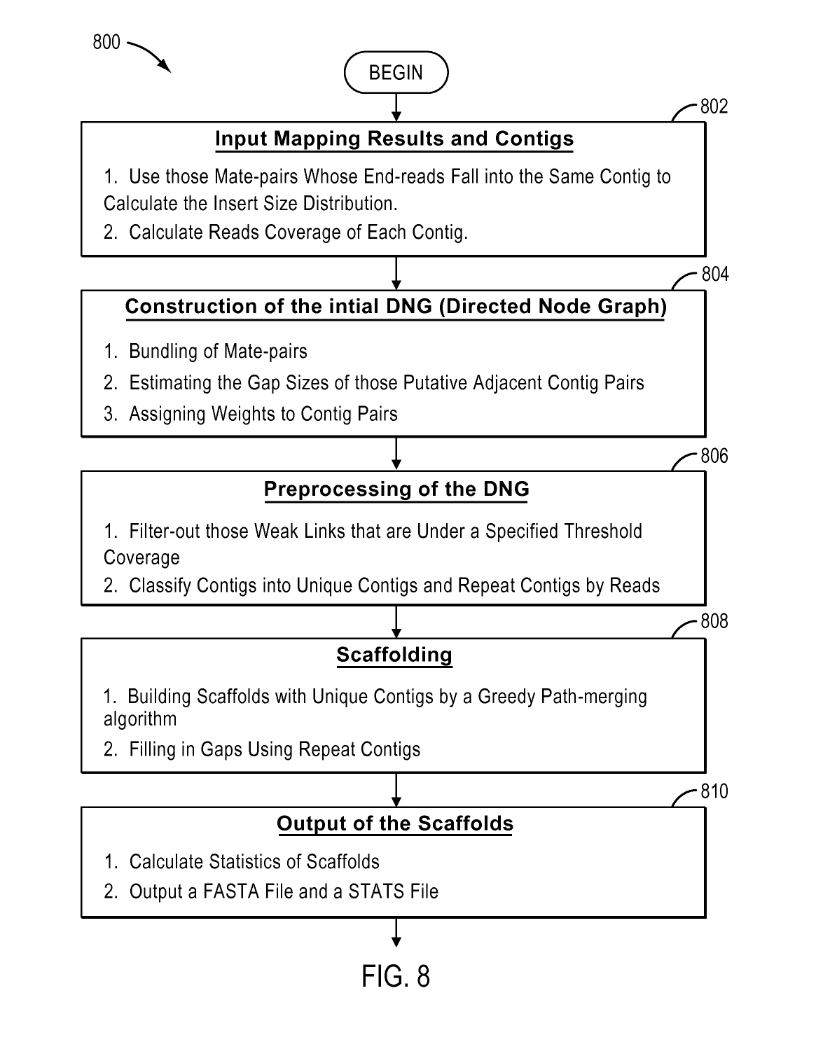

FIG. 8 is an exemplary flowchart detailing how the scaffolding module assembles the contigs and fragment reads into a scaffold of a longer nucleic acid sequence, in accordance with various embodiments. The scaffolding module 208 plays the key role in the de novo hybrid assembly pipeline. The scaffolding module 208 follows a similar process as that of conventional stand-alone scaffolders with some novel characteristics such as (but not limited to) using a directed node graph (DNG) internally to represent the relationship among contigs. In various embodiments, the process executed by scaffolding module 208 is as follows: first (step 802), the insert size distribution is calculated based on those mate-pairs whose end reads fall into the same contig; second (step 804), the mate pairs whose end reads fall into the same pair of contig-ends are bundled, where each pair of contig ends corresponds to a possible combination of contig order and orientations; third (step 806), the gap sizes of those putative adjacent contig pairs are estimated based on a Bayesian approximation which takes into account the contig sizes, insert size distribution and the locations of the relevant matepairs on those contigs; fourth (step 808), contigs are classified into unique-contigs (or unitigs) and repeat-contigs based on maximum likelihood estimation of the expected times that the contig C occurs in the genome G under the binomial assumption, i.e. k·|G|/n·|C|, where n is the number of reads from G, k of which fall into C; Fifth (step 810), scaffolds are built from unitigs using a greedy path-merging algorithm; sixth, gaps are filled using repeat contigs if there exist sufficient mate-pairs supporting this linkage.

The gap-fill module 210 can be configured to fill the intra-scaffold gaps using the mate-pairs with one end read mapping to a contig and the other likely to fall in a gap between contigs. Since the hanging mates are constrained in a narrow range, the overlap layout consensus (OLC) approach is used for massive local assembly due to its robustness. For the gaps that are harder to fill, parameters can be manually set for the third-party assembler. Later a dynamic programming algorithm is used to translate the aligned local assembly from color-space to base-space.

In various embodiments, two metrics can be defined to determine assembly accuracy besides N50 length. The mismatch error rate can be defined as: Mis.=1−|Reference∩Assembly|/|ReferenceUAssembly|, where |Reference∩Assembly| is the total number of bases on the assembly fragments that can be continuously mapped to the reference genome with a minimum identity threshold of 90%. The total rearrangement error frequency is defined as: Rea.=|Rearrange events|×10⁶/|Reference|. In other words, it defines the number of events of large indels (>10 bp), translocations and inversions per Mbp.

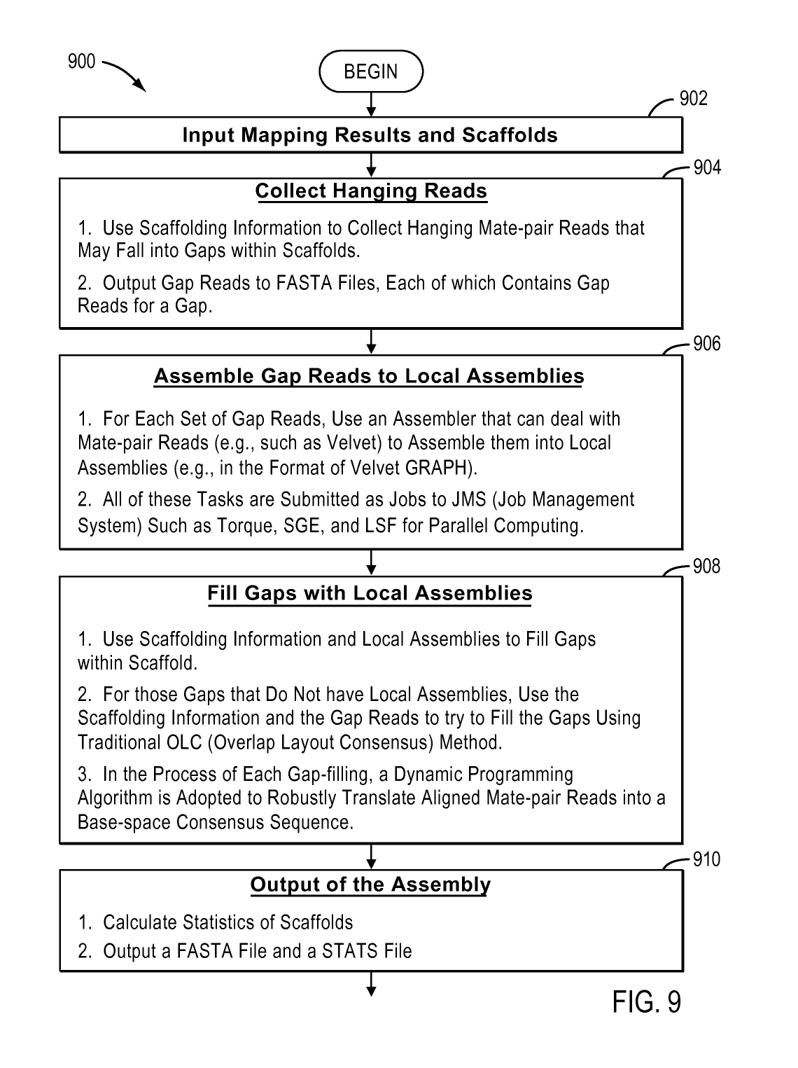

FIG. 9 is an exemplary flowchart detailing how the gap-filling module operates to fill in the gap regions in the scaffold, in accordance with various embodiments. As shown herein, in step 902, the mapping results from mapping module 206 and the scaffold output from scaffolding module 208 are received by gap-filling module 210. In step 904, hanging mate-pair reads are collected. In step 906, the gap reads are assembled to local assemblies. That is, a mate-pair read processing capable assembler is used to assemble the hanging mate-pair reads into local assemblies. In step 908, the gaps in the scaffold are filled using the local assemblies. That is, the scaffolding information and local assemblies are used to fill the gaps within the scaffold. For those gaps that do not have local assemblies, a traditional OLC method can be employed to use the scaffolding information and gap reads to fill the gaps. In step 910, the gap-filled scaffold is output from gap-filling module 210.

Client terminal 212 can be a thin client or thick client computing device. In various embodiments, client terminal 212 can have a web browser (e.g., INTERNET EXPLORER™ FIREFOX™, SAFARI™, etc) that can be used to control the operation of the contig assembly module 202, the pre-processing module 204 (optional), the mapping module 206, the mapping error correction module 207 (optional), the scaffolding module 208, and the gap-fill module 210. That is, the client terminal 212 can access the contig assembly module 202, the pre-processing module 204 (optional), the mapping module 206, the mapping error correction module 207 (optional), the scaffolding module 208 and/or the gap-fill module 210 using a browser to control their function. For example, the client terminal 212 can be used to configure the operating parameters (e.g., mismatch constraint, quality value thresholds, etc.) of the various engines, depending on the requirements of the particular application. Similarly, client terminal 212 can also display the results of the analysis performed by the contig assembly module 202, the pre-processing module 204 (optional), the mapping module 206, the mapping error correction module 207 (optional), the scaffolding module 208, and the gap-fill module 210.

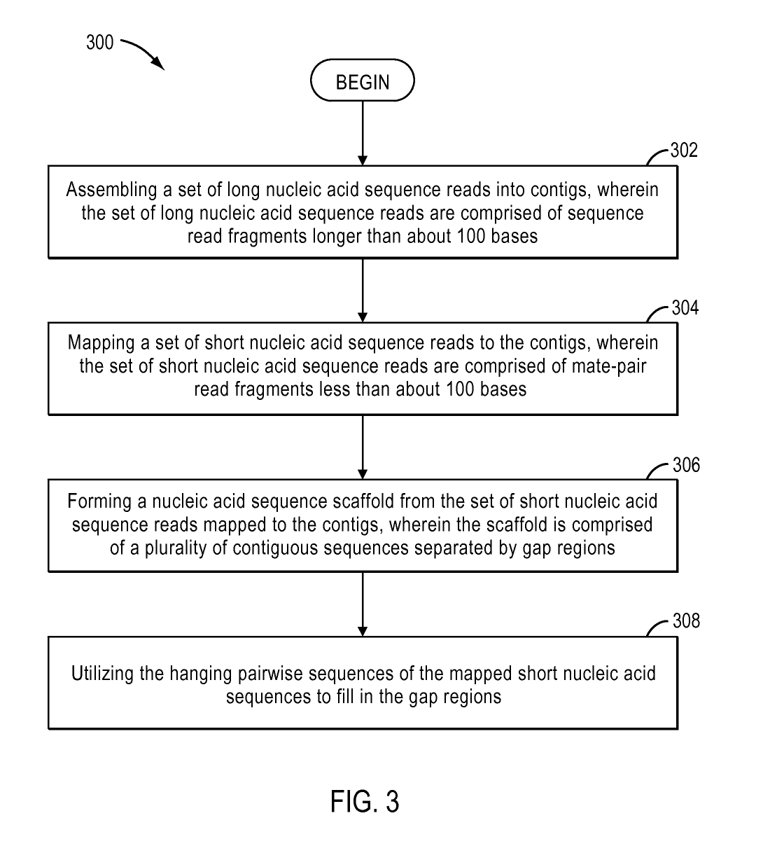

FIG. 3 is a flowchart showing a de novo assembly method, in accordance with various embodiments.

Method 300 begins with step 302 where a set of long nucleic acid sequence reads is assembled into contigs (wherein the set of long nucleic acid sequence reads are comprised of sequence read fragments longer than about 100 bps). In step 304, a set of short nucleic acid sequence reads is mapped to the contigs (wherein the set of short nucleic acid sequence reads are comprised of mate-pair read fragments less than about 100 bps). In step 306, a nucleic acid sequence scaffold is formed from the set of short nucleic acid sequence reads mapped to the contigs (wherein the scaffold is comprised of a plurality of contiguous sequences separated by gap regions). In step 308, the hanging pairwise sequences of the mapped short nucleic acid sequences are utilized to fill in the gap regions.

It should be understood, however, that the various modules shown as being part of the system 200 can be combined or collapsed into a single module, depending on the requirements of the particular application or system architecture. Moreover, in various embodiments, the system 200 can comprise additional modules, engines or components as needed by the particular application or system architecture.

In various embodiments, the system 200 can be configured to process the nucleic acid reads in color space. In various embodiments, system 200 can be configured to process the nucleic acid reads in base space. It should be understood, however, that the system 200 disclosed herein can process or analyze nucleic acid sequence data in any schema or format as long as the schema or format can convey the base identity and position of the nucleic acid sequence.

### Bridging Mapped Read Gaps for De Novo Assembly

Described herein is a genome assembly (i.e., ASiD) workflow that emphasizes the availability of mate-paired/paired-end reads (paired reads) to address challenges in de novo assembly of NGS sequence reads.

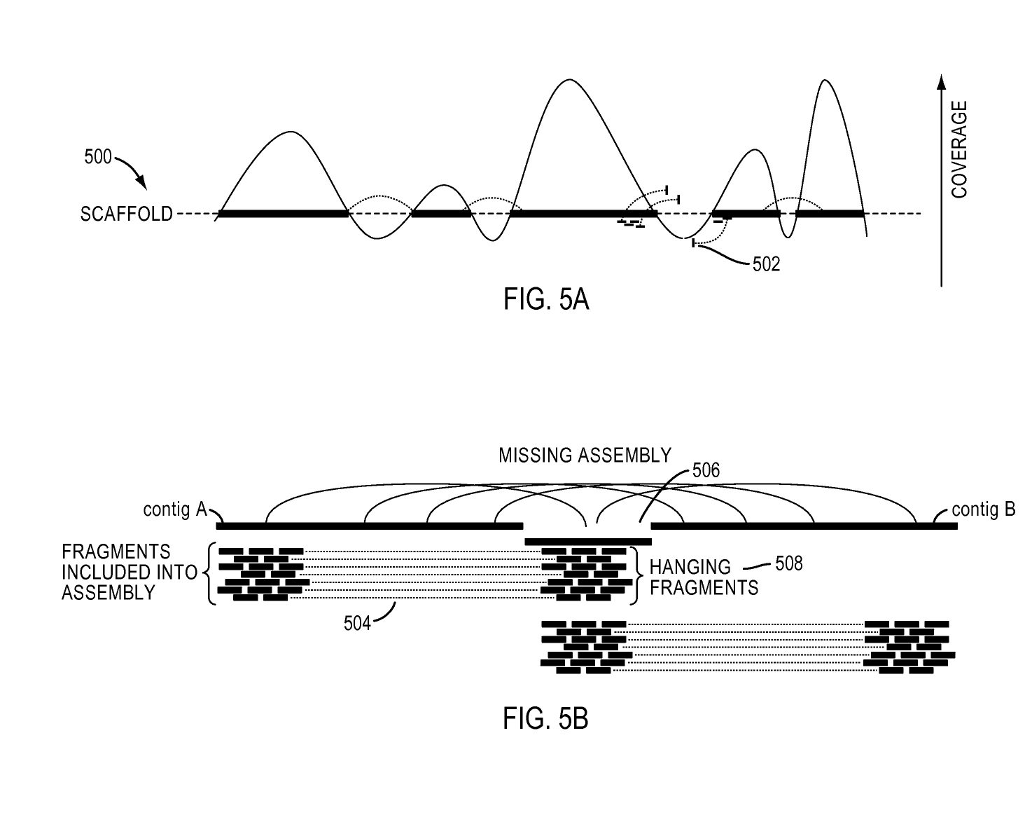

FIGS. 5A and 5B are diagrams showing how a hanging mate pair gap-fill technique can be applied to de novo assembly applications to fill in gap areas in a nucleic acid sequence scaffold assembled from mate-pair sequences mapped to contigs, in accordance with various embodiments.

For example, as depicted in FIG. 5A, the scaffold 500 assembled by the scaffolding module 208 can be comprised of a plurality of contigs that are separated by gap regions. The hanging pairwise sequences of the assembled reads (that form the contigs) can be assembled to fill in the gap regions of the scaffold 500. This is clearly illustrated in FIG. 5B where the various hanging fragments 508 of the mapped reads 504 are shown overlapping one another in the gap region 506.

### Nucleic Acid Sequencing Platforms

Nucleic acid sequence data can be generated using various techniques, platforms or technologies, including, but not limited to: capillary electrophoresis, microarrays, ligation-based systems, polymerase-based systems, hybridization-based systems, direct or indirect nucleotide identification systems, pyrosequencing, ion- or pH-based detection systems, electronic signature-based systems, etc.

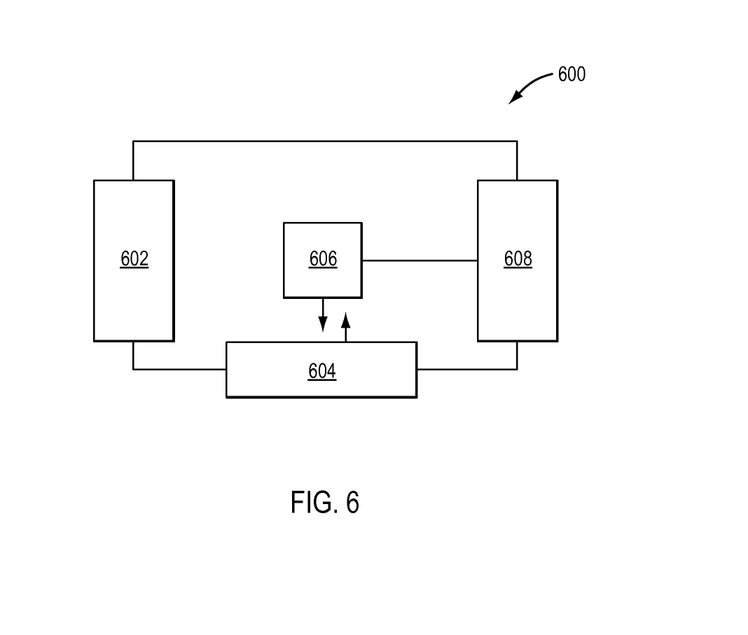

Various embodiments of nucleic acid sequencing platforms (i.e., nucleic acid sequencer) can include components as displayed in the block diagram of FIG. 6. According to various embodiments, sequencing instrument 600 can include a fluidic delivery and control unit 602, a sample processing unit 604, a signal detection unit 606, and a data acquisition, analysis and control unit 608. Various embodiments of instrumentation, reagents, libraries and methods used for next generation sequencing are described in U.S. Patent Application Publication No. 2007/066931(application Ser. No. 11/737,308) and U.S. Patent Application Publication No. 2008/003571 (application Ser. No. 11/345,979) to McKernan, et al., which applications are incorporated herein by reference. Various embodiments of instrument 1100 can provide for automated sequencing that can be used to gather sequence information from a plurality of sequences in parallel, i.e., substantially simultaneously.

In various embodiments, the fluidics delivery and control unit 602 can include reagent delivery system. The reagent delivery system can include a reagent reservoir for the storage of various reagents. The reagents can include RNA-based primers, forward/reverse DNA primers, oligonucleotide mixtures for ligation sequencing, nucleotide mixtures for sequencing-by-synthesis, optional ECC oligonucleotide mixtures, buffers, wash reagents, blocking reagent, stripping reagents, and the like. Additionally, the reagent delivery system can include a pipetting system or a continuous flow system which connects the sample processing unit with the reagent reservoir.

In various embodiments, the sample processing unit 604 can include a sample chamber, such as flow cell, a substrate, a micro-array, a multi-well tray, or the like. The sample processing unit 604 can include multiple lanes, multiple channels, multiple wells, or other means of processing multiple sample sets substantially simultaneously. Additionally, the sample processing unit can include multiple sample chambers to enable processing of multiple runs simultaneously. In particular embodiments, the system can perform signal detection on one sample chamber while substantially simultaneously processing another sample chamber. Additionally, the sample processing unit can include an automation system for moving or manipulating the sample chamber.

In various embodiments, the signal detection unit 606 can include an imaging or detection sensor. For example, the imaging or detection sensor can include a CCD, a CMOS, an ion sensor, such as an ion sensitive layer overlying a CMOS, a current detector, or the like. The signal detection unit 606 can include an excitation system to cause a probe, such as a fluorescent dye, to emit a signal. The expectation system can include an illumination source, such as arc lamp, a laser, a light emitting diode (LED), or the like. In particular embodiments, the signal detection unit 606 can include optics for the transmission of light from an illumination source to the sample or from the sample to the imaging or detection sensor. Alternatively, the signal detection unit 606 may not include an illumination source, such as for example, when a signal is produced spontaneously as a result of a sequencing reaction. For example, a signal can be produced by the interaction of a released moiety, such as a released ion interacting with an ion sensitive layer, or a pyrophosphate reacting with an enzyme or other catalyst to produce a chemiluminescent signal. In another example, changes in an electrical current can be detected as a nucleic acid passes through a nanopore without the need for an illumination source.

In various embodiments, data acquisition analysis and control unit 608 can monitor various system parameters. The system parameters can include temperature of various portions of instrument 600, such as sample processing unit or reagent reservoirs, volumes of various reagents, the status of various system subcomponents, such as a manipulator, a stepper motor, a pump, or the like, or any combination thereof.

It will be appreciated by one skilled in the art that various embodiments of instrument 600 can be used to practice variety of sequencing methods including ligation-based methods, sequencing by synthesis, single molecule methods, nanopore sequencing, and other sequencing techniques. Ligation sequencing can include single ligation techniques, or change ligation techniques where multiple ligation are performed in sequence on a single primary. Sequencing by synthesis can include the incorporation of dye labeled nucleotides, chain termination, ion/proton sequencing, pyrophosphate sequencing, or the like. Single molecule techniques can include continuous sequencing, where the identity of the nuclear type is determined during incorporation without the need to pause or delay the sequencing reaction, or staggered sequence, where the sequencing reactions is paused to determine the identity of the incorporated nucleotide.

In various embodiments, the sequencing instrument 600 can determine the sequence of a nucleic acid, such as a polynucleotide or an oligonucleotide. The nucleic acid can include DNA or RNA, and can be single stranded, such as ssDNA and RNA, or double stranded, such as dsDNA or a RNA/cDNA pair. In various embodiments, the nucleic acid can include or be derived from a fragment library, a mate pair library, a ChIP fragment, or the like. In particular embodiments, the sequencing instrument 600 can obtain the sequence information from a single nucleic acid molecule or from a group of substantially identical nucleic acid molecules.

In various embodiments, sequencing instrument 600 can output nucleic acid sequencing read data in a variety of different output data file types/formats, including, but not limited to: *.fasta, *.csfasta, *seq.txt, *qseq.txt, *.fastq, *.sff, *prb.txt, *.sms, *srs and/or *.qv.

While the present teachings are described in conjunction with various embodiments, it is not intended that the present teachings be limited to such embodiments. On the contrary, the present teachings encompass various alternatives, modifications, and equivalents, as will be appreciated by those of skill in the art.

Further, in describing various embodiments, the specification may have presented a method and/or process as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process should not be limited to the performance of their steps in the order written, and one skilled in the art can readily appreciate that the sequences may be varied and still remain within the spirit and scope of the various embodiments.

The embodiments described herein, can be practiced with other computer system configurations including hand-held devices, microprocessor systems, microprocessor-based or programmable consumer electronics, minicomputers, mainframe computers and the like. The embodiments can also be practiced in distributing computing environments where tasks are performed by remote processing devices that are linked through a network.

It should also be understood that the embodiments described herein can employ various computer-implemented operations involving data stored in computer systems. These operations are those requiring physical manipulation of physical quantities. Usually, though not necessarily, these quantities take the form of electrical or magnetic signals capable of being stored, transferred, combined, compared, and otherwise manipulated. Further, the manipulations performed are often referred to in terms, such as producing, identifying, determining, or comparing.

Any of the operations that form part of the embodiments described herein are useful machine operations. The embodiments, described herein, also relate to a device or an apparatus for performing these operations. The systems and methods described herein can be specially constructed for the required purposes or it may be a general purpose computer selectively activated or configured by a computer program stored in the computer. In particular, various general purpose machines may be used with computer programs written in accordance with the teachings herein, or it may be more convenient to construct a more specialized apparatus to perform the required operations.

Certain embodiments can also be embodied as computer readable code on a computer readable medium. The computer readable medium is any data storage device that can store data, which can thereafter be read by a computer system. Examples of the computer readable medium include hard drives, network attached storage (NAS), read-only memory, random-access memory, CD-ROMs, CD-Rs, CD-RWs, magnetic tapes, and other optical and non-optical data storage devices. The computer readable medium can also be distributed over a network coupled computer systems so that the computer readable code is stored and executed in a distributed fashion.

What is claimed is:

1. A computer implemented method for assembling a nucleic acid sequence, comprising:
receiving, into a memory, a plurality of single fragment sequence reads and a plurality of paired fragment sequence reads, each paired fragment sequence read comprising at least two sequence reads separated by an insert;
assembling the single fragment sequence reads into a plurality of contigs;
mapping the paired fragment sequence reads to the contigs;
identifying a gap region comprising a portion of the partially assembled nucleic acid sequence for which the single fragment sequence reads do not map, and
utilizing hanging pairwise sequence reads of the mapped paired fragment sequence reads to fill in the gap region using a processor.

2. The computer implemented method of claim 1, further comprising estimating a size of the gap region based on a size of the contigs, an insert size distribution, and mapped locations of paired fragment sequence reads spanning the gap region.

3. The computer implemented method of claim 2, further comprising determining the insert size distribution from paired fragment sequence reads having both sequence reads mapped to a same contig.

4. The computer implemented method of claim 1, further comprising identifying first and second contigs as adjacent when a first sequence read of a paired fragment sequence read is mapped to the first contig and a second sequence read of a paired fragment sequence read is mapped to the second contig.

5. The computer implemented method of claim 1, further comprising classifying contigs of the plurality of contigs as unique contigs or repeat contigs.

6. The computer implemented method of claim 1, further comprising determining a mismatch error rate.

7. The computer implemented method of claim 1, further comprising determining a rearrangement error frequency.

8. The computer implemented method of claim 1, further comprising using a directed node graph to represent the relationships between the plurality of contigs.

9. A system for assembling a nucleic acid sequence, comprising:
a computing device, including:
a contig assembly engine configured to assemble single fragment sequence reads into one or more contigs;
a mapping engine configured to map a plurality of paired fragment sequence reads to the assembled contigs, each paired fragment sequence read comprising at least two sequence reads separated by an insert;
a scaffolding engine configured to form a sequence scaffold from the mapped paired fragment sequence reads and contigs; and
a gap-filling engine configured to utilize hanging pairwise sequences of the mapped paired fragment sequence reads to fill in gap regions in the sequence scaffold.

10. The system of claim 9, wherein the single fragment sequence reads have a length of greater than about 100 bases.

11. The system of claim 9, wherein the scaffolding engine is further configured to estimate the size of the gap region based on a size of the contigs, an insert size distribution, and mapped locations of paired fragment sequence reads spanning the gap region.

12. The system of claim 11, wherein the scaffolding engine is further configured to determine the insert size distribution from paired fragment sequence reads having both sequence reads mapped to a same contig.

13. The system of claim 9, wherein the scaffolding engine is further configured to identify first and second contigs as adjacent when a first sequence read of a paired fragment sequence read is mapped to the first contig and a second sequence read of a paired fragment sequence read is mapped to the second contig.

14. The system of claim 9, wherein the contig assembly engine is further configured to classify contigs of the plurality of contigs as unique contigs or repeat contigs.

15. The system of claim 9, wherein the scaffolding engine is further configured to use a directed node graph to represent the relationships between the plurality of contigs.

16. A non-transitory computer readable media having a computer readable program code embodied therein, the computer readable program code adapted to be executed by a processor to implement a method for annotating called variants in a sample genome, comprising:
receiving a plurality of single fragment sequence reads and a plurality of paired fragment sequence reads, each paired fragment sequence read comprising at least two sequence reads separated by an insert;
assembling the single fragment sequence reads into a plurality of contigs;
mapping the paired fragment sequence reads to the contigs;
identifying a gap region comprising a portion of the partially assembled nucleic acid sequence for which the single fragment sequence reads do not map; and
utilizing hanging pairwise sequence of the mapped paired fragment sequence reads to fill in the gap region.

17. The non-transitory computer readable media of claim 16, further comprising estimating a size of the gap region based on a size of the contigs, an insert size distribution, and mapped locations of paired fragment sequence reads spanning the gap region.

18. The non-transitory computer readable media of claim 17, further comprising determining the insert size distribution from paired fragment sequence reads having both sequence reads mapped to a same contig.

19. The non-transitory computer readable media of claim 16, further comprising using a directed node graph to represent the relationships between the plurality of contigs.

20. The non-transitory computer readable media of claim 16, further comprising identifying first and second contigs as adjacent when a first sequence read of a paired fragment sequence read is mapped to the first contig and a second sequence read of a paired fragment sequence read is mapped to the second contig.
